(19) United States
(12) Patent Application Publication
(10) Pub. No.: US 2013/0338321 A1
(43) Pub. Date: Dec. 19, 2013

(54) Process for Improving Bulk Density with Multi-Contact Procatalyst and Product

(71) Applicants: Joseph N. Coalter, III, Lake Jackson, TX (US); Linfeng Chen, Missouri City, TX (US); Clark C. Williams, Lake Jackson, TX (US)

(72) Inventors: Joseph N. Coalter, III, Lake Jackson, TX (US); Linfeng Chen, Missouri City, TX (US); Clark C. Williams, Lake Jackson, TX (US)

(21) Appl. No.: 14/002,019

(22) PCT Filed: Feb. 29, 2012
(86) PCT No.: PCT/US12/27086

§ 371 Date: Aug. 28, 2013

Related U.S. Application Data
(60) Provisional application No. 61/447,800, filed on Mar. 1, 2011.

(51) Int. Cl. C08F 4/10; C08F 4/52

(52) U.S. Cl. CPC C08F 4/10; C08F 4/52
USPC 526/125.7; 502/104; 502/152; 526/124.2; 526/185

(57) ABSTRACT

Disclosed herein are processes for preparing procatalyst compositions which include multiple contact steps in the presence of a substituted phenylene aromatic diester and at least one other internal electron donor. The multi-contact procatalyst compositions produced from the present processes improve polymer properties and polymerization parameters. In particular, the present multi-contact procatalyst compositions improve polymer bulk density.

### BACKGROUND

The present disclosure provides a process for enhancing procatalyst and catalyst properties. The present disclosure provides formant polymers produced by these procatalysts/catalysts.

Worldwide demand for olefin-based polymers continues to grow as applications for these polymers become more diverse and more sophisticated. Known are Ziegler-Natta catalyst compositions for the production of olefin-based polymers. Ziegler-Natta catalyst compositions typically include a procatalyst containing a transition metal halide (i.e., titanium, chromium, vanadium), a cocatalyst such as an organoaluminum compound, and optionally an external electron donor. Ziegler-Natta catalyzed olefin-based polymers typically exhibit a narrow range of molecular weight distribution. Given the perennial emergence of new applications for olefin-based polymers, the art recognizes the need for olefin-based polymers with improved and varied properties.

Known are catalyst compositions containing a substituted phenylene aromatic diester as an internal electron donor used for the production of olefin-based polymers. Desirable would be Ziegler-Natta procatalyst compositions containing a substituted phenylene aromatic diester that increases the bulk density of the formant polymer particles. Further desired is a Ziegler-Natta procatalyst composition containing a substituted phenylene aromatic diester that provides high catalyst activity during polymerization.

### SUMMARY

The present disclosure provides processes for producing a Ziegler-Natta procatalyst composition containing mixed internal electron donor, one component of which is a substituted phenylene aromatic diester. The Applicant discovered that procatalyst synthesis which includes (i) multiple contact steps (ii) in the presence of a substituted phenylene aromatic diester and another internal electron donor surprisingly improves catalyst properties and polymerization parameters. The present processes improve catalyst selectivity and catalyst activity. The present processes produce procatalyst/catalyst compositions which yield improved polymer bulk density during polymerization. Propylene-based polymer produced from the present procatalyst/catalyst compositions exhibit low xylene solubles, high T_{MF}, good morphology and expanded in-reactor melt flow range.

The present disclosure provides a process. In an embodiment, a process for producing a procatalyst composition is provided and includes first contacting a procatalyst precursor with a halogenating agent in the presence of an internal electron donor. The internal electron donor is selected from a substituted phenylene aromatic diester, a benzoate-based component, an alkoxyalkyl ester, and combinations thereof. The first contact step forms a procatalyst intermediate. The process includes second contacting the procatalyst intermediate with a halogenating agent in the presence of an internal electron donor. The internal electron donor is selected from a substituted phenylene aromatic diester, a benzoate-based component, an alkoxyalkyl ester, and combinations thereof. At least one of the contact steps occurs in the presence of a substituted phenylene aromatic dibenzoate. The process includes forming a multi-contact procatalyst composition.

In an embodiment, the process includes forming a residual composition.

The disclosure provides another process. In an embodiment, a process for producing a procatalyst composition is provided and includes first contacting a procatalyst composition with a halogenating agent in the presence of a substituted phenylene aromatic dibenzoate and an alkoxyalkyl ester to form a procatalyst intermediate. The process includes second contacting the procatalyst intermediate with a halogenating agent in the presence of an internal electron donor. The internal electron donor is selected from a substituted phenylene aromatic diester, an alkoxyalkyl ester, and combinations thereof. The process includes forming a multi-contact procatalyst composition. The multi-contact procatalyst composition includes a substituted phenylene aromatic diester and an alkoxyalkyl ester.

The disclosure provides another process. In an embodiment, a process for producing a procatalyst composition is provided and includes first contacting a procatalyst composition with a halogenating agent in the presence of a benzoate-based component to form a procatalyst intermediate. The process includes second contacting the procatalyst intermediate with a halogenating agent in the presence of a substituted phenylene aromatic diester. The process includes forming a multi-contact procatalyst composition. The multi-contact procatalyst composition includes a substituted phenylene aromatic diester and a benzoate-based component.

The disclosure provides a composition. In an embodiment, a catalyst composition is provided and includes a multi-contact procatalyst composition, a cocatalyst, and optionally an external electron donor. In a further embodiment, the catalyst composition includes a residual composition.

The disclosure provides another process. In an embodiment, a polymerization process is provided and includes contacting, under polymerization conditions, propylene and optionally one or more comonomers with a catalyst composition. The catalyst composition includes a multi-contact procatalyst composition, a cocatalyst and an external electron donor. The process includes forming particles of a propylene-based polymer having a bulk density greater than 0.30 g/cc.

An advantage of the present disclosure is provision of a process for the production of a multi-contact procatalyst composition.

An advantage of the present disclosure is the provision of a catalyst composition containing a multi-contact procatalyst composition.

An advantage of the present disclosure is the provision of a multi-contact procatalyst composition which produces polymer particles with improved bulk density.

An advantage of the present disclosure is a polymerization process which utilizes a multi-contact procatalyst composition to improve polymer bulk density.

An advantage of the present disclosure is a phthalate-free multi-contact procatalyst/catalyst composition.

An advantage of the present disclosure is the provision of a phthalate-free catalyst composition and a phthalate-free olefin-based polymer produced therefrom.

### BRIEF DESCRIPTION OF THE DRAWINGS

FIG. 1 depicts a reaction scheme that occurs during the multi-contact procatalyst composition production process in accordance with an embodiment of the present disclosure.

FIG. 2 depicts a reaction scheme that occurs during the procatalyst composition production process in accordance with an embodiment of the present disclosure.

### DETAILED DESCRIPTION

The present disclosure provides a process for producing a procatalyst composition which includes (i) multiple (i.e., two or more) contact steps and (ii) an internal electron donor composed of at least a substituted phenylene aromatic diester. The present process improves one or more of the following procatalyst properties: activity, selectivity, hydrogen response, and/or catalyst particle morphology. The present process further improves the following polymerization process parameters: polymer bulk density and/or reactor throughput rate/mass.

In an embodiment, a process for producing a procatalyst composition is provided. The process includes first contacting a procatalyst precursor with a halogenating agent in the presence of an internal electron donor selected from one or more of the following: a substituted phenylene aromatic diester, a benzoate-based component, an alkoxyalkyl ester, and combinations thereof. The first contact step forms a procatalyst intermediate. The process further includes second contacting the procatalyst intermediate with a halogenating agent in the presence of an internal electron donor selected from one or more of the following: a substituted phenylene aromatic diester, a benzoate-based component, an alkoxyalkyl ester, and combinations thereof. At least one of the first contact and/or second contact steps occurs in the presence of a substituted phenylene aromatic diester. The process further includes forming a multi-contact procatalyst composition.

In an embodiment, the multi-contact procatalyst composition is contains a residual composition. The residual composition is the result of the (i) multiple contacts that occur in the presence of (ii) the multiple internal electron donors.

Procatalyst Precursor

The procatalyst precursor contains magnesium and may be a magnesium moiety compound (MagMo), a mixed magnesium titanium compound (MagTi), or a benzoate-containing magnesium chloride compound (BenMag). In an embodiment, the procatalyst precursor is a magnesium moiety (“MagMo”) precursor. The “MagMo precursor” contains magnesium as the sole metal component. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carbonated magnesium dialkoxide or aryloxide. In one embodiment, the MagMo precursor is a magnesium di (C₁₋₄) alkoxide. In a further embodiment, the MagMo precursor is diethoxymagnesium.

In an embodiment, the procatalyst precursor is a mixed magnesium/titanium compound (“MagTi”). The “MagTi precursor” has the formula Mg_{d}Ti(OR^{e})_{f}X_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The MagTi precursor is prepared by controlled precipitation through removal of an alcohol from the precursor reaction medium used in their preparation. In an embodiment, a reaction medium comprises a mixture of an aromatic liquid, such as a chlorinated aromatic compound, or chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having desirable morphology and surface area. In a further embodiment, the resulting procatalyst precursor is a plurality of particles that are uniform in particle size.

In an embodiment, the procatalyst precursor is a benzoate-containing magnesium chloride material. As used herein, a “benzoate-containing magnesium chloride” (“BenMag”) can be a procatalyst (i.e., a halogenated procatalyst precursor) containing a benzoate internal electron donor. The BenMag material may also include a titanium moiety, such as a titanium halide. The benzoate internal donor is labile and can be replaced by other electron donors during procatalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. Nonlimiting examples of suitable BenMag procatalyst precursors include procatalysts of the trade names SHAC™ 103 and SHAC™ 310 available from The Dow Chemical Company, Midland, Mich. In an embodiment, the BenMag procatalyst precursor may be a product of halogenation of any procatalyst precursor (i.e., a MagMo precursor or a MagTi precursor) in the presence of a benzoate compound.

First Contact

The present process includes first contacting the procatalyst precursor with a halogenating agent in the presence of an internal electron donor selected from one or more of the following: a substituted phenylene aromatic diester, a benzoate-based component, an alkoxyalkyl ester, and combinations thereof. The first contact forms a procatalyst intermediate. The term “contacting,” or “contact,” or “contact step” in the context of procatalyst synthesis, is the chemical reaction that occurs in a reaction mixture (optionally heated) containing a procatalyst precursor/intermediate, a halogenating agent (with optional titanating agent) an internal electron donor, and a solvent. The reaction product of “contacting” is a procatalyst composition (or a procatalyst intermediate) that is a combination of a magnesium moiety, a titanium moiety, complexed with the internal electron donor(s).

Halogenation (or halogenating) occurs by way of a halogenating agent. A “halogenating agent,” as used herein, is a compound that converts the procatalyst precursor (or procatalyst intermediate) into a halide form. A “titanating agent,” as used herein, is a compound that provides the catalytically active titanium species. Halogenation and titanation convert the magnesium moiety present in the procatalyst precursor into a magnesium halide support upon which the titanium moiety (such as a titanium halide) is deposited.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In this way, the titanium halide is simultaneously the halogenating agent and the titanating agent. In a further embodiment, the titanium halide is TiCl₄ and halogenation occurs by way of chlorination of the procatalyst precursor with the TiCl₄. The chlorination (and titanation) is conducted in the presence of a chlorinated or a non-chlorinated aromatic or aliphatic liquid, such as dichlorobenzene, o-chlorotoluene, chlorobenzene, benzene, toluene, xylene, octane, or 1,1,2-trichloroethane. In yet another embodiment, the halogenation and the titanation are conducted by use of a mixture of halogenating agent and chlorinated aromatic liquid comprising from 40 to 60 volume percent halogenating agent, such as TiCl₄.

In an embodiment, the reaction mixture is heated to a temperature from about 30° C. to about 150° C. for a duration of about 2 minutes to about 100 minutes during halogenation (chlorination).

Internal Electron Donor

The process includes first contacting the procatalyst precursor with a halogenating agent in the presence of an internal electron donor. As used herein, an “internal electron donor” (or “IED”) is a compound added or otherwise formed during formation of the procatalyst composition that donates at least one pair of electrons to one or more metals present in the resultant procatalyst composition. Not wishing to be bound by any particular theory, it is believed that during halogenation (and titanation) the internal electron donor (1) regulates the formation of active sites and thereby enhances catalyst stereoselectivity, (2) regulates the position of titanium on the magnesium-based support, (3) facilitates conversion of the magnesium and titanium moieties into respective halides and (4) regulates the crystallite size of the magnesium halide support during conversion. Thus, provision of the internal electron donor yields a procatalyst composition with enhanced stereoselectivity.

The internal electron donor is added before, during, or after the heating of the reaction mixture. The internal electron donor may be added before, during, or after addition of the halogenating agent to the procatalyst precursor. At least a portion of the halogenation of the procatalyst precursor proceeds in the presence of the internal electron donor.

A. Substituted Phenylene Aromatic Dibenzoate

The internal electron donor includes a substituted phenylene aromatic diester. The substituted phenylene aromatic diester is a component of the first contact and/or the second contact. The substituted phenylene aromatic diester may be a substituted 1,2-phenylene aromatic diester, a substituted 1,3-phenylene aromatic diester, or a substituted 1,4-phenylene aromatic diester. In an embodiment, a 1,2-phenylene aromatic diester is provided. The substituted 1,2-phenylene aromatic diester has the structure (I) below.

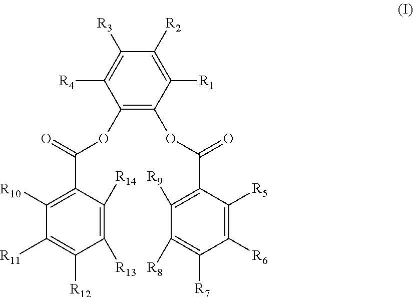

R₁-R₁₄ are the same or different. Each of R₁-R₁₄ is selected from a hydrogen, substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. At least one of R₁-R₁₄ is not hydrogen. A “substituted phenylene aromatic diester,” (or “SPAD”) as used herein, is a 1,2-phenylene aromatic diester of structure (I) wherein at least one of the R₁-R₁₄ is not hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl- groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In an embodiment, the substituted phenylene aromatic diester is 3-methyl-5-t-butyl-1,2-phenylene dibenzoate.

B. Benzoate-Based Component

The internal electron donor may include a benzoate-based component. A “benzoate-based component,” as used herein, is one or more of the following: ethyl benzoate, benzoyl chloride, benzoic anhydride, and p-ethyoxy-ethylbenzoate.

C. Alkoxyalkyl Ester

The internal electron donor may include an alkoxyalkyl ester. In an embodiment, the alkoxyalkyl ester (or “AE”) is an alkoxyethyl ester. The alkoxyakyl ester has the structure (II) set forth below.

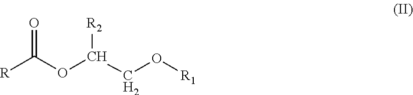

R, R₁ and R₂ are the same or different. Each of R, R₁ and R₂ is selected from hydrogen (except R₁ which is not hydrogen), a C₁-C₂₀ hydrocarbyl group, and a substituted C₁-C₂₀ hydrocarbyl group. In an embodiment, each of R₁ and R₂ is selected from a substituted/unsubstituted C₁-C₂₀ primary alkyl group or from a substituted/unsubstituted alkene group with the structure (III) below.

C(H)═C(R₁₁)(R₁₂) (III)

R₁₁ and R₁₂ are the same or different. Each of R₁₁ and R₁₂ is selected from hydrogen and a C₁-C₁₈ hydrocarbyl group.

In an embodiment, the alkoxyalkyl ester is an aromatic alkoxyalkyl ester (or “AAE”). The aromatic alkoxyalkyl ester excludes the benzoate-based component. The aromatic alkoxyalkyl ester may be an aromatic alkoxyethyl ester with the structure (IV) below.

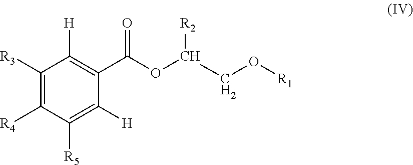

R₁ and R₂ are the same or different. R₁ is selected from a C₁-C₂₀ primary alkyl group and a substituted C₁-C₂₀ primary alkyl group. R₂ is selected from hydrogen, a C₁-C₂₀ primary alkyl group, and a substituted C₁-C₂₀ primary alkyl group. In an embodiment, each of R₁ and R₂ is selected from a C₁-C₂₀ primary alkyl group or from an alkene group with the structure (III) below.

C(H)═C(R₁₁)(R₁₂) (III)

R₁₁ and R₁₂ are the same or different. Each of R₁₁ and R₁₂ is selected from hydrogen and a C₁-C₁₈ hydrocarbyl group.

R₃, R₄, R₅ of structure (IV) are the same or different. Each of R₃, R₄, and R₅ is selected from hydrogen, a heteroatom, a C₁-C₂₀ hydrocarbyl group, a substituted C₁-C₂₀ hydrocarbyl group, and a C₁-C₂₀ hydrocarbyloxy group, and any combination thereof.

In an embodiment, the AAE is 1-methoxypropan-2-yl benzoate.

In an embodiment, the AAE is 2-methoxyethyl benzoate.

In an embodiment, the alkoxyalkyl ester includes an acrylate moiety and has the structure (V) below.

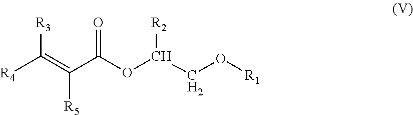

R₁ and R₂ are the same or different. Each of R₁ and R₂ is selected from hydrogen (except R₁ which is not hydrogen), a C₁-C₂₀ hydrocarbyl group, and a substituted C₁-C₂₀ hydrocarbyl group and combinations thereof. In an embodiment, each of R₁ and R₂ is selected from a substituted/unsubstituted C₁-C₂₀ primary alkyl group or from an alkene group with the structure (III) below.

C(H)═C(R₁₁)(R₁₂) (III)

R₁₁ and R₁₂ are the same or different. Each of R₁₁ and R₁₂ is selected from hydrogen and a C₁-C₁₈ hydrocarbyl group.

R₃, R₄, R₅ of structure (V) are the same or different. Each of R₃, R₄, and R₅ is selected from hydrogen, a heteroatom, a C₁-C₂₀ hydrocarbyl group, and a substituted C₁-C₂₀ hydrocarbyl group and any combination thereof R₃, R₄, and/or R₅ may form one or more rings.

In an embodiment, the first contact step occurs in a reaction mixture. The process includes reacting the halogenating agent with the procatalyst precursor in the reaction mixture and adding the alkoxyalkyl ester to the reaction mixture from greater than 0 minutes to about 30 minutes after the reacting. The reaction mixture may be heated to a temperature from 30° C. to 150° C. before, during, or after the internal electron donor addition to the reaction mixture.

Second Contact

The first contact step forms a procatalyst intermediate. The process includes second contacting the procatalyst intermediate with a halogenating agent in the presence of an internal electron donor selected from one or more of the following: a substituted phenylene aromatic diester, a benzoate-based component, and an alkoxyalkyl ester. In other words, a halogenating agent and additional internal electron donor are added to the procatalyst intermediate to form the procatalyst composition. The procatalyst intermediate may be isolated from the initial reaction mixture prior to being subjected to the second contact step (or third contact step). The halogenating agent used in the second contact may be the same or different than the halogenating agent of the first contact. The internal electron donor used in the second contact step may be one, two, or more different internal electron donors.

During the second contact, the internal electron donor may be added before, during, or after heating of the second reaction mixture. The internal electron donor may be added before, during, or after addition of the halogenating agent to the procatalyst intermediate. The reaction mixture of the second contact is heated to a temperature of 30° C. to 150° C. for a duration of about 2 minutes to about 100 minutes.

The first contact step and the second contact step form a multi-contact procatalyst composition. A “multi-contact procatalyst composition” as used herein, is a procatalyst composition containing (i) a titanium moiety, (ii) a magnesium moiety, (iii) a SPAD, (iv) a benzoate-based component and/or an alkoxyalkyl ester and (v) is formed by two or more contact steps during procatalyst synthesis.

Residual Composition

In an embodiment, the multi-contact procatalyst composition contains one or more residual composition(s). The term “residual composition,” as used herein is an aromatic composition other than the SPAD which may or may not be chemically bound to the titanium or magnesium moiety.

Nonlimiting examples of residual compositions include the following structures (VI)-(X) set forth below.

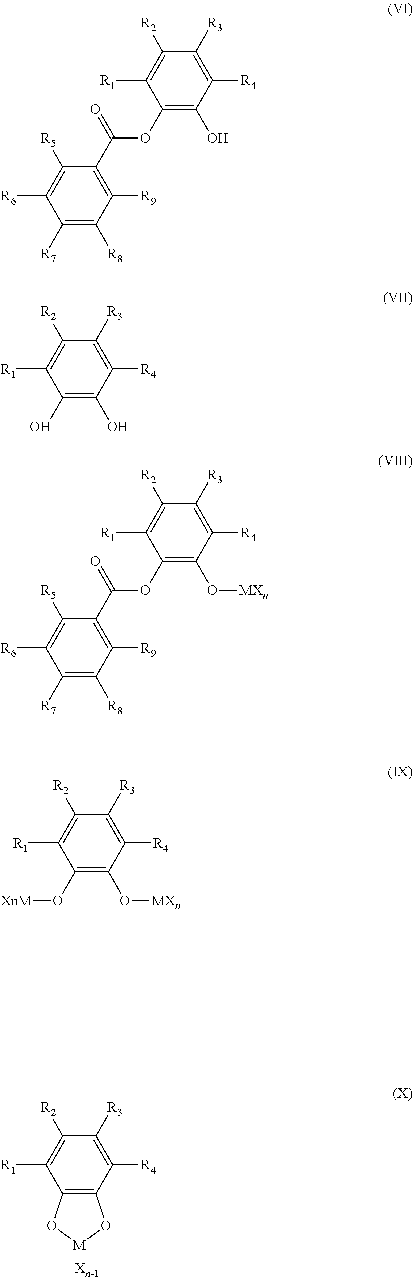

For structures (VI)-(X), R₁-R₉ are the same or different. Each of R₁-R₉ is selected from hydrogen and a C₁-C₆ hydrocarbyl group. In an embodiment, each of R₅-R₉ is hydrogen. M is magnesium or titanium. If M is magnesium then n is 1. If M is titanium, then n is 3. X is a halogen (F, Cl, Br, I) atom.

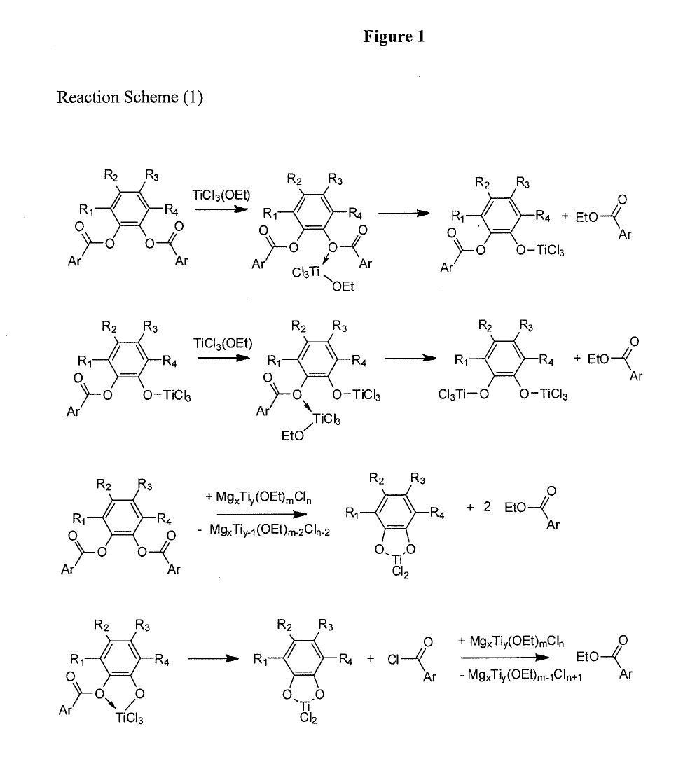

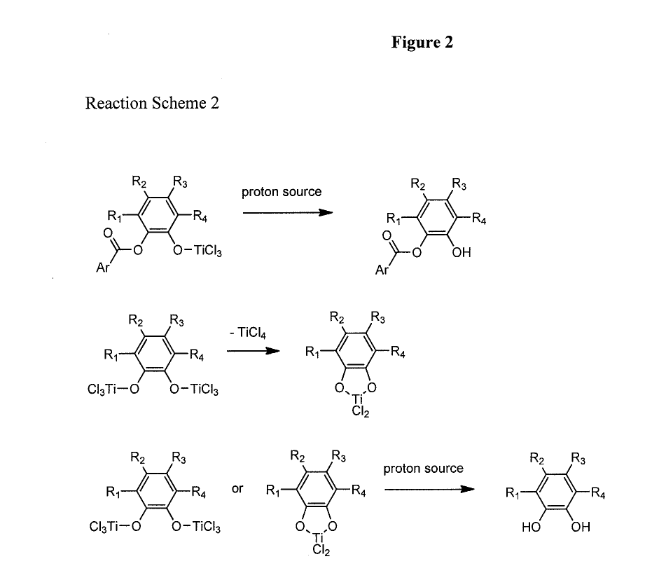

FIGS. 1 and 2 depict reactions that occur during procatalyst synthesis. Shown in FIGS. 1 and 2 are nonlimiting examples of the conversion of substituted phenylene aromatic diester into residual compositions.

Applicant has surprisingly discovered that (i) multiple contacts in the presence of a (ii) substituted phenylene aromatic diester and at least one other internal electron donor, unexpectedly produces a procatalyst composition with improved morphology. Bounded by no particular theory, it is believed that the multiple contacts produce smoother or more rounded procatalyst composition particles when compared to non-multi-contact procatalyst composition. Catalyst composition containing the multi-contact procatalyst composition produces polymer particles that are smoother and more rounded when compared to polymer particles produced from catalysts not containing the multi-contact procatalyst composition. The smooth and spherical polymer particle morphology resulting from the multi-contact procatalyst composition unexpectedly improves the bulk density of the polymer particles formed from catalyst composition containing the multi-contact procatalyst composition. In addition, the multi-contact procatalyst composition also improves catalyst activity.

In an embodiment, the present process includes third contacting the procatalyst intermediate with a halogenating agent in the presence of an internal electron donor selected from one or more of the following: a substituted phenylene aromatic diester, a benzoate-based component, and an alkoxyalkyl ester. The internal electron donor of the third contact step may be the same or different than the internal electron donor of the first contact step and/or the second contact step. The reaction mixture may be the same or different than the reaction mixture of the first contact and/or the second contact. The reaction mixture during the third contact step may be heated to a temperature of 30° C. to 150° C. for a duration of about 2 minutes to about 100 minutes. In the third contact step, the internal electron donor may be added before, during, or after heating. The process may include four, five, or more contact steps.

The present disclosure provides another process. In an embodiment, a process for producing a procatalyst composition is provided and includes first contacting a procatalyst precursor with a halogenating agent in the presence of a substituted phenylene aromatic diester and an alkoxyalkyl ester to form a procatalyst intermediate. The process includes second contacting the procatalyst intermediate with a halogenating agent in the presence of an internal electron donor selected from a phenylene aromatic diester, an alkoxyalkyl ester, and combinations thereof. The process includes forming a multi-contact procatalyst composition comprising a combination of a magnesium moiety, a titanium moiety, the substituted phenylene aromatic diester and the alkoxyalkyl ester.

In an embodiment, the process includes forming a procatalyst composition containing greater than 1.0 wt % of the alkoxyalkyl ester.

In an embodiment, the process includes second contacting the procatalyst intermediate with a halogenating agent in the presence of an alkoxyalkyl ester.

In an embodiment, the process includes second contacting the procatalyst intermediate with a halogenating agent in the presence of a substituted phenylene aromatic dibenzoate and an alkoxyalkyl ester.

In an embodiment, the process includes third contacting the procatalyst intermediate with an alkoxyalkyl ester.

The present disclosure provides another process. In an embodiment, a process for producing a procatalyst composition is provided and includes first contacting a procatalyst composition with a halogenating agent in the presence of a benzoate-based component to form a procatalyst intermediate. The process includes second contacting the procatalyst intermediate with a halogenating agent in the presence of a substituted phenylene aromatic diester and/or optionally in the presence of a benzoate-based component. The process includes forming a multi-contact procatalyst composition composed of a substituted phenylene aromatic diester and a benzoate-based component.

The first contact step occurs in the absence of the SPAD. In other words, the first contact step is void of SPAD. Applicant has surprisingly discovered that pre-contact between the procatalyst precursor, halogenating agent, and a benzoate-based component prior to contact in the presence of the SPAD surprisingly improves procatalyst morphology and polymer bulk density in particular.

In an embodiment, the second contact step includes contacting the procatalyst intermediate with a halogenating agent in the presence of a substituted phenylene aromatic diester.

In an embodiment, the process includes second contacting the procatalyst intermediate with a benzoate-based component and third contacting the procatalyst intermediate with a halogenating agent in the presence of a substituted phenylene aromatic diester.

Ethoxide content in the procatalyst composition indicates the completeness of conversion of precursor metal ethoxide into a metal halide. The multiple contact steps promote conversion of ethoxide into halide during halogenation. In an embodiment, the process includes forming a procatalyst composition having from about 0.01 wt %, or 0.05 wt % to about 1.0 wt %, or about 0.7 wt % ethoxide. Weight percent is based on the total weight of the procatalyst composition.

In any of the foregoing processes, the procatalyst composition may be rinsed or washed with a liquid diluent to remove unreacted TiCl₄ and may be dried to remove residual liquid, after or between halogenation steps. Typically the resultant solid procatalyst composition is washed one or more times with a “wash liquid,” which is a liquid hydrocarbon such as an aliphatic hydrocarbon such as isopentane, isooctane, isohexane, hexane, pentane, or octane. Not wishing to be bound by any particular theory, it is believed that (1) further halogenation and/or (2) further washing results in desirable modification of the procatalyst composition, possibly by removal of certain undesired metal compounds that are soluble in the foregoing diluent.

Any of the foregoing processes may comprise two or more embodiments disclosed herein.

The present disclosure provides a multi-contact procatalyst composition produced by any of the foregoing processes. The resultant multi-contact procatalyst composition has a titanium content of from about 1.0 wt %, or about 1.5 wt %, or about 2.0 wt %, to about 6.0 wt %, or about 5.5 wt %, or about 5.0 wt %. The weight ratio of titanium to magnesium in the solid procatalyst composition is suitably between about 1:3 and about 1:160, or between about 1:4 and about 1:50, or between about 1:6 and 1:30. The internal electron donor(s) may be present in the procatalyst composition in a molar ratio of internal electron donor(s) to magnesium of from about 0.005:1 to about 1:1, or from about 0.01:1 to about 0.4:1. Weight percent is based on the total weight of the procatalyst composition.

In an embodiment, the magnesium moiety is a magnesium chloride. The titanium moiety is a titanium chloride.

In an embodiment, a multi-contact procatalyst composition is provided and includes a combination of a magnesium moiety, a titanium moiety, a substituted phenylene aromatic diester and a residual composition. The residual composition can be any residual composition as previously disclosed and including structures (VI)-(X) above. The procatalyst composition contains from about 0.1 wt % to about 20 wt % of the residual composition. Weight percent is based on total weight of the procatalyst composition.

Another multi-contact procatalyst composition is provided. In an embodiment, a procatalyst composition is provided and includes a combination of a magnesium moiety, a titanium moiety, a substituted phenylene aromatic diester and a benzoate-based component. The benzoate-based component can be any benzoate-based component previously disclosed above. The procatalyst composition contains from about 0.1 wt % to about 20 wt % of the benzoate-based component. Weight percent is based on total weight of the procatalyst composition. In an embodiment, the substituted phenylene aromatic diester is 3-methyl-5-t-butyl-1,2-phenylene dibenzoate.

Another multi-contact procatalyst composition is provided. In an embodiment, a procatalyst composition is provided and includes a combination of a magnesium moiety, a titanium moiety, a substituted phenylene aromatic diester and an alkoxyalkyl ester. The alkoxyalkyl ester can be any alkoxyalkyl ester previously disclosed and including structures (IV)-(V) above. The procatalyst composition contains from about 0.1 wt % to about 20 wt % of the alkoxyalkyl ester. Weight percent is based on total weight of the procatalyst composition. In an embodiment, the substituted phenylene aromatic diester is 3-methyl-5-t-butyl-1,2-phenylene dibenzoate.

In an embodiment, the alkoxyalkyl ester is 2-methoxyethyl benzoate.

In an embodiment, the alkoxyalkyl ester is 1-methoxypropan-2-yl benzoate.

The multi-contact procatalyst composition may comprise two or more embodiments disclosed herein.

Catalyst Composition

The disclosure provides another composition. In an embodiment, a catalyst composition is provided and includes a multi-contact procatalyst composition, a cocatalyst and optionally an external electron donor. The multi-contact procatalyst composition may be any multi-contact procatalyst composition as previously disclosed herein.

As used herein, a “cocatalyst” is a substance capable of converting the procatalyst to an active polymerization catalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum compound represented by the formula RₙAlX₃₋ₙ wherein n=1, 2, or 3, R is an alkyl, and X is a halide or alkoxide. In an embodiment, the cocatalyst is selected from trimethylaluminum, triethylaluminum, triisobutylaluminum, and tri-n-hexylaluminum.

Nonlimiting examples of suitable hydrocarbyl aluminum compounds are as follows: methylaluminoxane, isobutylaluminoxane, diethylaluminum ethoxide, diisobutylaluminum chloride, tetraethyldialuminoxane, tetraisobutyldialuminoxane, diethylaluminum chloride, ethylaluminum dichloride, methylaluminum dichloride, dimethylaluminum chloride, triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum, diisobutylaluminum hydride, and di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

The catalyst composition optionally includes an external electron donor. As used herein, an “external electron donor” (or “EED”) is a compound added independent of procatalyst formation and includes at least one functional group that is capable of donating a pair of electrons to a metal atom. Bounded by no particular theory, it is believed that provision of one or more external electron donors in the catalyst composition affects the following properties of the formant polymer: level of tacticity (i.e., xylene soluble material), molecular weight (i.e., melt flow), molecular weight distribution (MWD), and melting point.

In an embodiment, the EED is a silicon compound having the general formula (XI):

SiRₘ(OR′)₄₋ₘ (XI)

wherein R independently each occurrence is hydrogen or a hydrocarbyl or an amino group, optionally substituted with one or more substituents containing one or more Group 14, 15, 16, or 17 heteroatoms. R contains up to 20 atoms not counting hydrogen and halogen. R′ is a C₁₋₂₀ alkyl group, and m is 0, 1, 2, or 3. In an embodiment, R is C₆₋₁₂ aryl, alkyl or alkylaryl, C₃₋₁₂ cycloalkyl, C₃₋₁₂ branched alkyl, or C₂₋₁₂ cyclic amino group, R′ is C₁₋₄ alkyl, and m is 1 or 2.

In an embodiment, the silicon compound is dicyclopentyldimethoxysilane (DCPDMS), methylcyclohexyldimethoxysilane (MChDMS), or n-propyltrimethoxysilane (NPTMS), and any combination thereof. In a further embodiment, the EED is DCPDMS.

The catalyst composition may comprise two or more embodiments disclosed herein.

Polymerization

The present disclosure provides a polymerization process. Any of the foregoing catalyst compositions may be used in a polymerization process. In an embodiment, a polymerization process is provided and includes contacting, under polymerization conditions, propylene and optionally one or more olefins with a catalyst composition composed of a multi-contact procatalyst composition, a cocatalyst, and an external electron donor. The polymerization process includes forming particles of a propylene-based polymer having a bulk density greater than 0.30 g/cc, or from greater than 0.30 g/cc to 0.5 g/cc.

The multi-contact procatalyst composition may be any multi-contact procatalyst composition as previously disclosed herein. In an embodiment, the process includes forming propylene homopolymer having a bulk density greater than 0.30 g/cc to 0.5 g/cc.

In an embodiment, the process includes contacting the catalyst composition with propylene and ethylene and forming propylene/ethylene copolymer having a bulk density greater than 0.30 g/cc to 0.5 g/cc.

As used herein, “polymerization conditions” are temperature and pressure parameters within a polymerization reactor suitable for promoting polymerization between the catalyst composition and an olefin to form the desired polymer. The polymerization process may be a gas phase, a slurry, or a bulk polymerization process, operating in one, or more than one, polymerization reactor. Accordingly, the polymerization reactor may be a gas phase polymerization reactor, a liquid-phase polymerization reactor, or a combination thereof.

In an embodiment, the polymerization process includes forming a propylene-based polymer having less than 6 wt %, or less than 4 wt %, or less than 2.5 wt %, or less than 2 wt %, or from 0.1 wt % to less than 6 wt % xylene solubles (XS). Weight percent XS is based on the total weight of the polymer.

The polymerization reaction forms a propylene homopolymer or a propylene copolymer. Optionally, one or more olefin monomers can be introduced into a polymerization reactor along with the propylene to react with the procatalyst, cocatalyst, and EED and to form a polymer, or a fluidized bed of polymer particles. Nonlimiting examples of suitable olefin monomers include ethylene, C₄₋₂₀ α-olefins, such as 1-butene, 1-pentene, 1-hexene, 4-methyl-1-pentene, 1-heptene, 1-octene, 1-decene, 1-dodecene and the like.

In an embodiment, the polymerization process may include a pre-polymerization step and/or a pre-activation step.

In an embodiment, the process includes mixing the external electron donor with the procatalyst composition. The external electron donor can be complexed with the cocatalyst and mixed with the procatalyst composition (pre-mixed) prior to contact between the catalyst composition and the olefin. In another embodiment, the external electron donor can be added independently to the polymerization reactor.

In an embodiment, the process includes forming a propylene-based polymer (propylene homopolymer or propylene copolymer) containing a substituted phenylene aromatic diester along with a residual composition, and/or a benzoate-based component and/or an alkoxyalkyl ester. The propylene-based polymer has one or more of the following properties:
a melt flow rate (MFR) from about 0.01 g/10 min to about 800 g/10 min, or from about 0.1 g/10 min to about 200 g/10 min, or from about 0.5 g/10 min to about 150 g/10 min; and/or
a xylene solubles content from about 0.5% to about 10%, or from about 1.0% to about 8%, or from about 1.0% to about 6%, or from 0.1% to less than 5%; and/or
a polydispersity index (PDI) from about 3.0 to about 8.0, and/or
particles thereof with a bulk density greater than 0.30 g/cc to about 0.50 g/cc.

The propylene-based polymer may comprise two or more embodiments disclosed herein.

In an embodiment, the procatalyst composition, the catalyst composition, and/or the polymer produced therefrom are/is phthalate-free or are/is otherwise void or devoid of phthalate and derivatives thereof.

In an embodiment, the process produces a polymeric composition composed of particles of a propylene-based polymer (propylene homopolymer, propylene/α-olefin copolymer), the particles having a bulk density greater than 0.30 g/cc, or greater than 0.3 g/cc to 0.5 g/cc. The propylene-based polymer includes a substituted phenylene aromatic diester and a residual composition.

In an embodiment, the process produces a polymeric composition composed of particles of a propylene-based polymer, the particles having a bulk density greater than 0.3 g/cc or greater than 0.3 g/cc to 0.5 g/cc. The propylene-based polymer includes a substituted phenylene aromatic diester a benzoate-based component and/or an alkoxyalkyl ester.

### DEFINITIONS

All references to the Periodic Table of the Elements herein shall refer to the Periodic Table of the Elements, published and copyrighted by CRC Press, Inc., 2003. Also, any references to a Group or Groups shall be to the Groups or Groups reflected in this Periodic Table of the Elements using the IUPAC system for numbering groups. Unless stated to the contrary, implicit from the context, or customary in the art, all parts and percents are based on weight. For purposes of United States patent practice, the contents of any patent, patent application, or publication referenced herein are hereby incorporated by reference in their entirety (or the equivalent US version thereof is so incorporated by reference), especially with respect to the disclosure of synthetic techniques, definitions (to the extent not inconsistent with any definitions provided herein) and general knowledge in the art.

Any numerical range recited herein, includes all values from the lower value to the upper value, in increments of one unit, provided that there is a separation of at least 2 units between any lower value and any higher value. As an example, if it is stated that the amount of a component, or a value of a compositional or a physical property, such as, for example, amount of a blend component, softening temperature, melt index, etc., is between 1 and 100, it is intended that all individual values, such as, 1, 2, 3, etc., and all subranges, such as, 1 to 20, 55 to 70, 197 to 100, etc., are expressly enumerated in this specification. For values which are less than one, one unit is considered to be 0.0001, 0.001, 0.01 or 0.1, as appropriate. These are only examples of what is specifically intended, and all possible combinations of numerical values between the lowest value and the highest value enumerated, are to be considered to be expressly stated in this application. In other words, any numerical range recited herein includes any value or subrange within the stated range. Numerical ranges have been recited, as discussed herein, reference melt index, melt flow rate, and other properties.

The term “alkyl,” as used herein, refers to a branched or unbranched, saturated or unsaturated acyclic hydrocarbon radical. Nonlimiting examples of suitable alkyl radicals include, for example, methyl, ethyl, n-propyl, i-propyl, n-butyl, t-butyl, i-butyl (or 2-methylpropyl), etc. The alkyls have 1 and 20 carbon atoms.

The term “aryl,” as used herein, refers to an aromatic substituent which may be a single aromatic ring or multiple aromatic rings which are fused together, linked covalently, or linked to a common group such as a methylene or ethylene moiety. The aromatic ring(s) may include phenyl, naphthyl, anthracenyl, and biphenyl, among others. The aryls have 1 and 20 carbon atoms.

The terms “blend” or “polymer blend,” as used herein, is a blend of two or more polymers. Such a blend may or may not be miscible (not phase separated at molecular level). Such a blend may or may not be phase separated. Such a blend may or may not contain one or more domain configurations, as determined from transmission electron spectroscopy, light scattering, x-ray scattering, and other methods known in the art.

The term, “bulk density,” (or “BD”) as used herein, is the density of the polymer produced. Bulk density is determined by pouring the polymer resin through a standard powder funnel into a stainless standard cylinder and determining the weight of the resin for the given volume of the filled cylinder in accordance with ASTM D 1895B or equivalent.

The term “composition,” as used herein, includes a mixture of materials which comprise the composition, as well as reaction products and decomposition products formed from the materials of the composition.

The term “comprising,” and derivatives thereof, is not intended to exclude the presence of any additional component, step or procedure, whether or not the same is disclosed herein. In order to avoid any doubt, all compositions claimed herein through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

The term, “ethylene-based polymer,” as used herein, refers to a polymer that comprises a majority weight percent polymerized ethylene monomer (based on the total weight of polymerizable monomers), and optionally may comprise at least one polymerized comonomer.

The term “interpolymer,” as used herein, refers to polymers prepared by the polymerization of at least two different types of monomers. The generic term interpolymer thus includes copolymers, usually employed to refer to polymers prepared from two different monomers, and polymers prepared from more than two different types of monomers.

The term “olefin-based polymer” is a polymer containing, in polymerized form, a majority weight percent of an olefin, for example ethylene or propylene, based on the total weight of the polymer. Nonlimiting examples of olefin-based polymers include ethylene-based polymers and propylene-based polymers.

The term “polymer” is a macromolecular compound prepared by polymerizing monomers of the same or different type. “Polymer” includes homopolymers, copolymers, terpolymers, interpolymers, and so on. The term “interpolymer” means a polymer prepared by the polymerization of at least two types of monomers or comonomers. It includes, but is not limited to, copolymers (which usually refers to polymers prepared from two different types of monomers or comonomers, terpolymers (which usually refers to polymers prepared from three different types of monomers or comonomers), tetrapolymers (which usually refers to polymers prepared from four different types of monomers or comonomers), and the like.

A “primary alkyl group” has the structure —CH₂R₁ wherein R₁ is hydrogen or a substituted/unsubstituted hydrocarbyl group.

The term, “propylene-based polymer,” as used herein, refers to a polymer that comprises a majority weight percent polymerized propylene monomer (based on the total amount of polymerizable monomers), and optionally may comprise at least one polymerized comonomer.

A “secondary alkyl group” has the structure —CHR₁R₂ wherein each of R₁ and R₂ is a substituted/unsubstituted hydrocarbyl group.

The term “substituted alkyl,” as used herein, refers to an alkyl as just described in which one or more hydrogen atom bound to any carbon of the alkyl is replaced by another group such as a halogen, aryl, substituted aryl, cycloalkyl, substituted cycloalkyl, heterocycloalkyl, substituted heterocycloalkyl, halogen, haloalkyl, hydroxy, amino, phosphido, alkoxy, amino, thio, nitro, and combinations thereof. Suitable substituted alkyls include, for example, benzyl, trifluoromethyl and the like.

A “tertiary alkyl group” has the structure —CR₁R₂R₃ wherein each of R₁, R₂, and R₃ is a substituted/unsubstituted hydrocarbyl group.

### Test Methods

Melt flow rate (MFR) is measured in accordance with ASTM D 1238-01 test method at 230° C. with a 2.16 kg weight for propylene-based polymers.

Xylene Solubles (XS) is measured using a ¹H NMR method as described in U.S. Pat. No. 5,539,309, the entire content of which is incorporated herein by reference. XSV is xylene solubles as measured by Viscotek. XSH is xylene solubles as measure by 1H NMR (proton NMR).

By way of example and not by limitation, examples of the present disclosure will now be provided.

### EXAMPLES

### 1. Procatalyst Components

A. Procatalyst Precursor

MagTi-1 is a mixed Mag/Ti precursor with composition of Mg₃Ti(OEt)₈Cl₂ (a MagTi procatalyst precursor prepared according to example 1 in U.S. Pat. No. 6,825,146) with an average particle size of 50 micron. SHAC™ 310 is a benzoate-containing catalyst (a BenMag procatalyst precursor) with an average particle size of 27 micron) with ethyl benzoate as the internal electron donor made according to Example 2 in U.S. Pat. No. 6,825,146, the entire content of which is incorporated herein by reference.

B. Internal Electron Donor

1. Substituted Phenylene Aromatic Diester

Substituted phenylene aromatic diester may be synthesized in accordance with U.S. patent application Ser. No. 61/141,959 (Docket No. 68188) filed on Dec. 31, 2008, the entire content of which is incorporated by reference herein. Nonlimiting examples of suitable substituted phenylene aromatic diester are provided in Table 1 below.

TABLE 1

| Compound | Structure |
|---|---|
| 1,2-phenylene dibenzoate (comparative) | 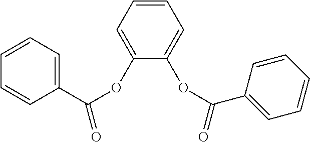 [SMILES: O=C(Oc1ccccc1OC(=O)c1ccccc1)c1ccccc1] |
| 3-methyl-5-tert- butyl-1,2- phenylene dibenzoate | 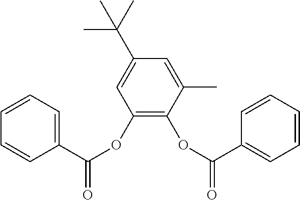 [SMILES: Cc1cc(C(C)(C)C)cc(OC(=O)c2ccccc2)c1OC(=O)c1ccccc1] |
| 3,5-diisopropyl- 1,2-phenylene dibenzoate | 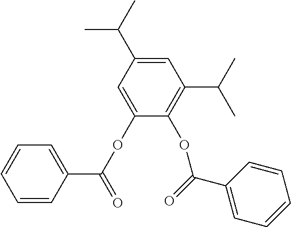 [SMILES: CC(C)c1cc(OC(=O)c2ccccc2)c(OC(=O)c2ccccc2)c(C(C)C)c1] |
| 3,6-dimethyl-1,2- phenylene dibenzoate | 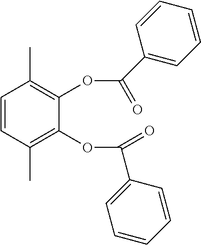 [SMILES: Cc1ccc(C)c(OC(=O)c2ccccc2)c1OC(=O)c1ccccc1] |
| 4-t-butyl-1,2- phenylene dibenzoate | 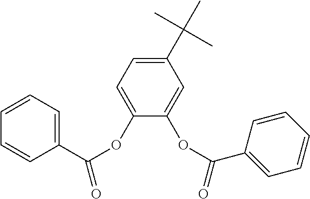 [SMILES: CC(C)(C)c1ccc(OC(=O)c2ccccc2)c(OC(=O)c2ccccc2)c1] |
| 4-methyl 1,2- phenylene dibenzoate | 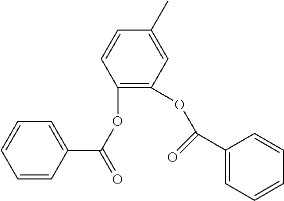 [SMILES: Cc1ccc(OC(=O)c2ccccc2)c(OC(=O)c2ccccc2)c1] |
| 1,2-naphthalene dibenzoate | 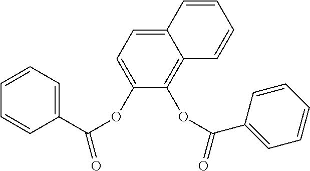 [SMILES: O=C(Oc1ccc2ccccc2c1OC(=O)c1ccccc1)c1ccccc1] |
| 2,3-naphthalene dibenzoate | 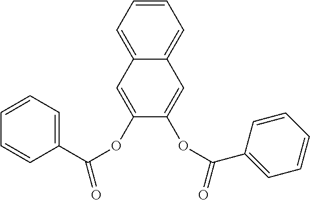 [SMILES: O=C(Oc1cc2ccccc2cc1OC(=O)c1ccccc1)c1ccccc1] |
| 3-methyl-5-tert- butyl-1,2- phenylene di(4- ethylbenzoate) | 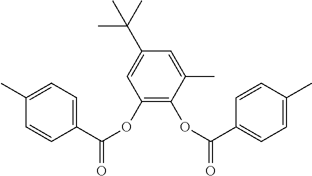 |
| 3-methyl-5-tert- butyl-1,2- phenylene di(2,4,6- trimethylbenzoate) | 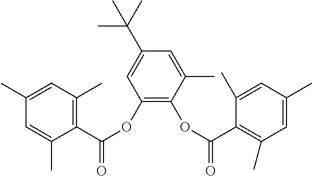 |
| 3-methyl-5-tert- butyl-1,2- phenylene di(4- fluorobenzoate) | 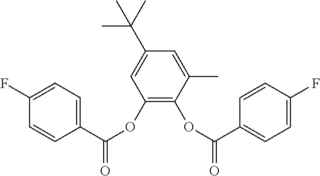 [SMILES: Cc1cc(C(C)(C)C)cc(OC(=O)c2ccc(F)cc2)c1OC(=O)c1ccc(F)cc1] |
| 3-methyl-5-tert- butyl-1,2- phenylene di(4- chlorobenzoate) | 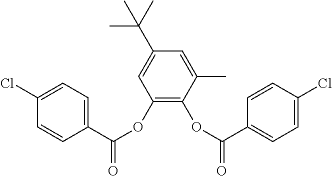 [SMILES: Cc1cc(C(C)(C)C)cc(OC(=O)c2ccc(Cl)cc2)c1OC(=O)c1ccc(Cl)cc1] |
| 3-methyl-6- isopropyl- 1,2-phenylene dibenzoate | 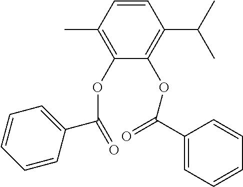 [SMILES: Cc1ccc(C(C)C)c(OC(=O)c2ccccc2)c1OC(=O)c1ccccc1] |
| 3,6-dimethyl-1,2- phenylene dibenzoate | 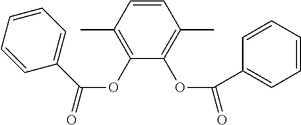 [SMILES: Cc1ccc(C)c(OC(=O)c2ccccc2)c1OC(=O)c1ccccc1] |
| 3,6-di-tert- butyl-1,2- phenylene dibenzoate | 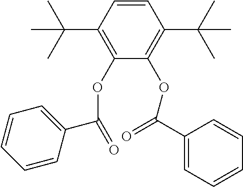 [SMILES: CC(C)(C)c1ccc(C(C)(C)C)c(OC(=O)c2ccccc2)c1OC(=O)c1ccccc1] |
| 3,4,6- triisopropyl-1,2- phenylene dibenzoate | 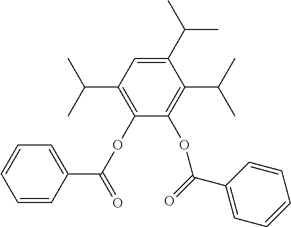 [SMILES: CC(C)c1cc(C(C)C)c(C(C)C)c(OC(=O)c2ccccc2)c1OC(=O)c1ccccc1] |
| 3,6-dimethyl-4- isopropyl-1,2- phenylene dibenzoate | 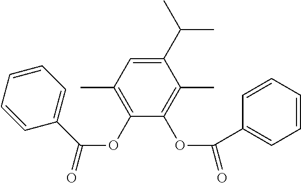 [SMILES: Cc1cc(C(C)C)c(C)c(OC(=O)c2ccccc2)c1OC(=O)c1ccccc1] |
| 3-methyl-1,2- phenylene dibenzoate | 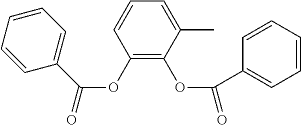 [SMILES: Cc1cccc(OC(=O)c2ccccc2)c1OC(=O)c1ccccc1] |
| 3-tert-butyl-1,2- phenylene dibenzoate | 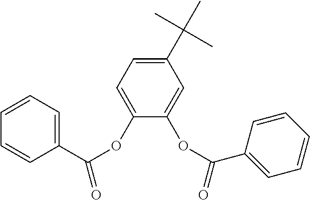 [SMILES: CC(C)(C)c1ccc(OC(=O)c2ccccc2)c(OC(=O)c2ccccc2)c1] |

2. Benzoate-Based Components

Nonlimiting examples of suitable benzoate-based components are provided in Table 2 below.

TABLE 2
Benzoate-based components

| | | |
|---|---|---|
| ethyl benzoate (CAS # 93-89-0) | EB | 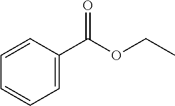 |
| benzoyl chloride (CAS # 98-88-4) | BC | 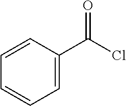 |
| ethyl 4- ethoxybenzoate (CAS # 23676-09-7) | PEEB | 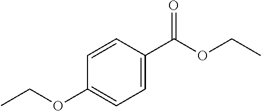 |
| benzoic anhydride (CAS # 93-97-0) | BA | 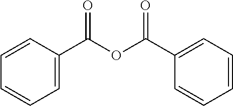 [SMILES: O=C(OC(=O)c1ccccc1)c1ccccc1] |

3. Alkoxyalkyl Esters

Nonlimiting examples of suitable alkoxyalkyl esters are provided in Table 3 below.

TABLE 3

| | | |
|---|---|---|
| 1-methoxypropan- 2-yl benzoate (CAS # 6290-26-2) | AAE | 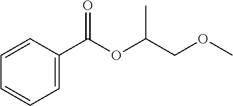 |
| 2-methoxyethyl benzoate (CAS # 5451-71-8) | AAE-2 | 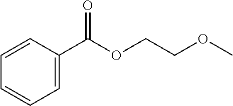 |

### 2. Catalyst Preparation

Under nitrogen, the specified mass of MagTi (mixed magnesium/titanium halide alcoholate; CAS #173994-66-6; U.S. Pat. No. 5,077,357) or SHAC™ 310 Catalyst (BenMag; benzoate-containing magnesium chloride compound), and 3-methyl-5-t-butyl-1,2-phenylene dibenzoate and/or optional other internal electron donor(s) as indicated in the Tables below, and 60 mL of a 50/50 (vol/vol) mixture of titanium tetrachloride and chlorobenzene is charged to a vessel equipped with an integral filter. After heating to the specified temperature for 60 minutes with stirring, the mixture is filtered. The solids are treated a second time with 60 mL of fresh 50/50 (vol/vol) mixed titanium tetrachloride/chlorobenzene, and optionally with a second charge of 3-methyl-5-t-butyl-1,2-phenylene dibenzoate and/or optional other internal electron donor, at the specified temperature for 30 minutes with stirring. The mixture is filtered. The solids are a third time treated with 60 mL of fresh 50/50 (vol/vol) mixed titanium tetrachloride/chlorobenzene, and optionally with a third charge of 3-methyl-5-t-butyl-1,2-phenylene dibenzoate and/or optional other internal electron donor, at the specified temperature for 30 minutes with stirring. The mixture is filtered. At ambient temperature, the solids are washed three times with 70 mL of isooctane, then dried under a stream of nitrogen. The solid catalyst components are collected as powders and a portion is mixed with mineral oil to produce a 2.5 or 5.0 wt % slurry. The identity of internal electron donor(s) used, their amounts, timing of addition, and other reaction conditions are detailed in the tables below.

### Generation of Active Polymerization Catalyst

In an inert atmosphere glovebox the active catalyst mixture is prepared by premixing the quantities indicated in Tables 4-12 of external donor (SCA), triethylaluminum (as a 0.28 M solution), supported catalyst component (as a mineral oil slurry), and 5-10 mL isooctane diluent (optional) for 20 minutes. After preparation, and without exposure to air, the active catalyst mixture is injected into the polymerization reactor as described below.

### 3. Polymerization

### Batch Reactor Propylene Polymerization (Homopolymer)

Polymerizations are conducted in a stirred, one gallon stainless steel autoclave. Temperature control is maintained by heating or cooling an integrated reactor jacket using a Budzar oil system. Reagents used for polymerization or catalyst preparation are passed through purification columns to remove impurities. Propylene and nitrogen are passed through two columns, the first containing Copper UT 2000, the second containing activated molecular sieves. Isooctane is passed through a single column containing activated molecular sieves, and hydrogen is ultra high purity grade gas, used as received.

The reactor is purged with approximately 300 grams of propylene and 500 gram of hydrogen while being heated to 50° C. and then while cooling to approximately 30° C. (to condition the reactor). The reactor is filled with 1375 g of propylene and the appropriate amount of hydrogen is added using a mass flow meter and the reactor is brought to 62° C. The active catalyst mixture is injected as a slurry in oil or light hydrocarbon and the injector is flushed with isooctane three times to ensure complete delivery. After injection of catalyst, the reactor temperature is ramped to 67° C. over 5 minutes, or maintained at 67° C. via cooling in the case of large exotherms. After a run time of 1 hour, the reactor contents are flushed to a secondary pressure vessel, vented of excess propylene, and purged with nitrogen at ambient temperature for 45 minutes. The polymer samples are then collected and polymer weights are measured after drying overnight or to constant weight in a ventilated fume hood. The reactor is cleaned after each run using isooctane, and placed under a nitrogen blanket until the subsequent polymerization run.

TABLE 4
Preparation of Catalysts Using BenMag as a Precursor

| | Precur- | 1^{st} TiCl₄ Contacting | | | 2^{nd} TiCl₄ Contacting | | | 3^{rd} TiCl₄ Contacting | | | | | | | |
|---|---|---|---|---|---|---|---|---|---|---|---|---|---|---|---|
| | sor | | SPAD | Additional | | SPAD | Additional | | SPAD | Additional | | | | | |
| Pro- | Amount | Temp | Amount | Donor | Temp | Amount | Donor | Temp | Amount | Donor | Ti | EtO | SPAD | EB | Other |
| Catalyst | (g) | (° C.) | (mmol) | (mmol) | (° C.) | (mmol) | (mmol) | (° C.) | (mmol) | (mmol) | (%) | (%) | (%) | (%) | (%) |
| Comp 1 | MagTi | 115 | | DiBP | 115 | | | 115 | | | 3.40 | 0.26 | | | DiBP |
| | (3.00 g) | | | (2.52) | | | | | | | | | | | (13.32) |
| Comp 2 | MagTi | 115 | (2.42) | | 115 | | | 115 | | | 4.03 | 0.45 | 20.82 | 1.53 | |
| | (3.00 g) | | | | | | | | | | | | | | |
| Cat 1 | SHAC | 115 | (2.52) | | 115 | | | 115 | | | 3.59 | 0.18 | 9.26 | 2.42 | |
| | 310 | | | | | | | | | | | | | | |
| | (2.00 g) | | | | | | | | | | | | | | |
| Cat 2 | SHAC | 115 | (1.76) | | 115 | (0.76) | | 115 | | | 3.03 | 0.25 | 14.36 | 1.34 | |
| | 310 | | | | | | | | | | | | | | |
| | (2.00 g) | | | | | | | | | | | | | | |

| | | | | | | | | | | |
|---|---|---|---|---|---|---|---|---|---|---|
| Cat 3 | SHAC | 115 | (2.52) | 115 | No 2nd TiCl₄ | 115 | No 3rd TiCl₄ | 3.20 | 0.21 | 8.70 |
| | 310 | | | | Contacting | | Contacting | | | |
| | (2.00 g) | | | | | | | | | |

TABLE 5
Polymerization Data from Catalysts Prepared Using BenMag as a Precursor

| | | | | MF | | | Activity | Pro- | | | |
|---|---|---|---|---|---|---|---|---|---|---|---|
| Run | Pro- | | BD | (g/10 | XSV | XSH | (kg/g- | catalyst | TEAl | Al/ | H₂ |
| # | Catalyst | SCA | (g/cc) | min) | (%) | (%) | hr) | (mg) | (mmol) | SCA | (scc) |
| 1C | Comp 1 | DCPDMS | 0.33 | 4.1 | 2.98 | 3.42 | 31.9 | 4.3 | 2 | 8 | 3000 |
| 2C | Comp 2 | DCPDMS | 0.22 | 1.4 | 2.46 | 1.74 | 53.5 | 4.3 | 2 | 8 | 3000 |
| 1 | Cat 1 | DCPDMS | 0.37 | 3.2 | 3.63 | 3.97 | 37.9 | 4.3 | 2 | 8 | 3000 |
| 2 | Cat 2 | DCPDMS | 0.39 | 2.3 | 2.11 | 2.77 | 41.9 | 4.3 | 2 | 8 | 3000 |
| 3 | Cat 3 | DCPDMS | 0.36 | 2.1 | 2.67 | 3.08 | 50.2 | 4.3 | 2 | 8 | 3000 |

TABLE 6
Preparation of Catalysts Adding Benzoyl Compounds as a Second Donor

| | | 1^{st} TiCl₄ Contacting | | | 2^{nd} TiCl₄ Contacting | | | 3^{rd} TiCl₄ Contacting | | | | | | | |
|---|---|---|---|---|---|---|---|---|---|---|---|---|---|---|---|
| | Precursor | | SPAD | Additional | | SPAD | Additional | | SPAD | Additional | | | | | |
| Pro- | Amount | Temp | Amount | Donor | Temp | Amount | Donor | Temp | Amount | Donor | Ti | EtO | SPAD | EB | Other |
| Catalyst | (g) | (° C.) | (mmol) | (mmol) | (° C.) | (mmol) | (mmol) | (° C.) | (mmol) | (mmol) | (%) | (%) | (%) | (%) | (%) |
| Comp 1 | MagTi | 115 | | DiBP | 115 | | | 115 | | | 3.40 | 0.26 | | | DiBP |
| | (3.00 g) | | | (2.52) | | | | | | | | | | | (13.32) |
| Comp 2 | MagTi | 115 | (2.42) | | 115 | | | 115 | | | 4.03 | 0.45 | 20.82 | 1.53 | |
| | (3.00 g) | | | | | | | | | | | | | | |
| Comp 3 | MagTi | 115 | (182) | | 115 | (0.60) | | 115 | | | 3.91 | 0.37 | 14.83 | 1.19 | |
| | (3.00 g) | | | | | | | | | | | | | | |
| Comp 4 | MagTi | 100 | (2.71) | | 115 | (1.16) | | 115 | | | 3.37 | 0.12 | 16.98 | 1.01 | |
| | (3.00 g) | | | | | | | | | | | | | | |
| Cat 4 | MagTi | 115 | (2.42) | EB | 115 | | | 115 | | | 3.92 | 0.12 | 6.41 | 6.18 | |
| | (3.00 g) | | | (2.52) | | | | | | | | | | | |
| Cat 5 | MagTi | 115 | (2.42) | EB | 115 | | | 115 | | | 3.09 | 0.29 | 5.62 | 5.41 | |
| | (2.00 g) | | | (2.52) | | | | | | | | | | | |
| Cat 6 | MagTi | 115 | (2.42) | BC | 115 | | BC | 115 | | BC | 2.70 | 0.12 | 3.50 | 4.13 | |
| | (2.00 g) | | | (2.52) | | | (2.52) | | | (2.52) | | | | | |
| Cat 7 | MagTi | 115 | (2.42) | EB | 115 | | EB | 115 | | BC | 2.84 | 0.19 | 3.93 | 2.04 | |
| | (2.00 g) | | | (2.52) | | | (2.52) | | | (2.52) | | | | | |
| Cat 8 | MagTi | 115 | (1.82) | EB | 115 | (0.60) | | 115 | | | 3.17 | 0.22 | 16.30 | 2.56 | |
| | (2.00 g) | | | (2.52) | | | | | | | | | | | |
| Cat 9 | MagTi | 115 | (1.82) | BC | 115 | (0.60) | BC | 115 | | BC | 2.98 | 0.19 | 12.20 | 1.55 | |
| | (2.00 g) | | | (2.52) | | | (2.52) | | | (2.52) | | | | | |
| Cat 10 | MagTi | 115 | (1.82) | EB | 115 | (0.60) | EB | 115 | | BC | 2.82 | 0.25 | 8.60 | 4.37 | |
| | (2.00 g) | | | (2.52) | | | (2.52) | | | (2.52) | | | | | |
| Cat 11 | MagTi | 100 | (2.71) | | 115 | (1.16) | | 115 | | EB | 3.22 | 0.12 | 12.14 | 4.68 | |
| | (3.00 g) | | | | | | | | | (2.52) | | | | | |
| Cat 12 | MagTi | 100 | (2.71) | | 115 | (1.16) | | 115 | | BA | 3.15 | 0.23 | 19.70 | 1.19 | |
| | (3.00) | | | | | | | | | (2.52) | | | | | |
| Cat 13 | MagTi | 100 | (2.71) | | 115 | (1.16) | | 115 | | PEEB | 3.23 | 0.43 | 14.12 | 0.69 | PEEB |
| | (3.00 g) | | | | | | | | | (2.52) | | | | | (1.35) |

TABLE 7
Polymerization Data of Catalysts Adding Benzoyl Compounds as a Second Donor

| | | | | MF | | | Activity | Pro- | | | |
|---|---|---|---|---|---|---|---|---|---|---|---|
| Run | Pro- | | BD | (g/10 | XSV | XSH | (kg/g- | catalyst | TEAl | Al/ | H₂ |
| # | Catalyst | SCA | (g/cc) | min) | (%) | (%) | hr) | (mg) | (mmol) | SCA | (scc) |
| 1C | Comp 1 | DCPDMS | 0.33 | 4.1 | 2.98 | 3.42 | 31.9 | 4.3 | 2 | 8 | 3000 |
| 2C | Comp 2 | DCPDMS | 0.22 | 1.4 | 2.46 | 1.74 | 53.5 | 4.3 | 2 | 8 | 3000 |
| 3C | Comp 3 | DCPDMS | 0.25 | 1.2 | 2.10 | 1.8 | 57.2 | 4.3 | 2 | 8 | 3000 |
| 4C | Comp 4 | DCPDMS | 0.24 | 0.8 | 1.08 | 1.41 | 65.8 | 4.3 | 2 | 8 | 3000 |
| 4 | Cat 4 | DCPDMS | 0.30 | 4.1 | 5.16 | 4.75 | 24.2 | 4.3 | 2 | 8 | 3000 |
| 5 | Cat 5 | DCPDMS | 0.31 | 7.5 | 5.13 | 4.94 | 26.3 | 4.3 | 2 | 8 | 3000 |
| 6 | Cat 6 | DCPDMS | 0.28 | 4.1 | 5.13 | 4.48 | 22.6 | 4.3 | 2 | 8 | 3000 |
| 7 | Cat 7 | DCPDMS | 0.29 | 4.1 | 5.07 | 4.9 | 15.8 | 4.3 | 2 | 8 | 3000 |
| 8 | Cat 8 | DCPDMS | 0.33 | 2.3 | 1.93 | 2.15 | 57.0 | 4.3 | 2 | 8 | 3000 |
| 9 | Cat 9 | DCPDMS | 0.26 | 1.1 | 2.18 | 1.75 | 58.8 | 4.3 | 2 | 8 | 3000 |
| 10 | Cat 10 | DCPDMS | 0.30 | 2.0 | 2.72 | 2.58 | 39.8 | 4.3 | 2 | 8 | 3000 |
| 11 | Cat 11 | DCPDMS | 0.37 | 1.4 | 1.47 | 2.29 | 67.9 | 4.3 | 2 | 8 | 3000 |
| 12 | Cat 12 | DCPDMS | 0.35 | 1.9 | 1.44 | 2.16 | 69.8 | 4.3 | 2 | 8 | 3000 |
| 13 | Cat 13 | DCPDMS | 0.37 | 1.4 | 1.14 | 1.91 | 40.0 | 4.3 | 2 | 8 | 3000 |

TABLE 8
Preparation of Catalysts Adding Alkoxyalkyl Ester Compounds as Second Donor

| | | 1^{st} TiCl₄ Contacting | | | 2^{nd} TiCl₄ Contacting | | | 3^{rd} TiCl₄ Contacting | | | | | | | |
|---|---|---|---|---|---|---|---|---|---|---|---|---|---|---|---|
| | Precursor | | | Additional | | SPAD | Additional | | SPAD | Additional | | | | | |
| Pro- | Amount | Temp | Amount | Donor | Temp | Amount | Donor | Temp | Amount | Donor | Ti | EtO | SPAD | EB | Other |
| Catalyst | (g) | (° C.) | (mmol) | (mmol) | (° C.) | (mmol) | (mmol) | (° C.) | (mmol) | (mmol) | (%) | (%) | (%) | (%) | (%) |
| Comp 1 | MagTi | 115 | | DiBP | 115 | | | 115 | | | 3.40 | 0.26 | | | DiBP |
| | (3.00 g) | | | (2.52) | | | | | | | | | | | (13.32) |
| Comp 2 | MagTi | 115 | (2.42) | | 115 | | | 115 | | | 4.03 | 0.45 | 20.82 | 1.53 | |
| | (3.00 g) | | | | | | | | | | | | | | |
| Comp 3 | MagTi | 115 | (1.82) | | 115 | (0.60) | | 115 | | | 3.91 | 0.37 | 14.83 | 1.19 | |
| | (3.00 g) | | | | | | | | | | | | | | |
| Cat 14 | MagTi | 115 | (2.42) | AAE | 115 | | AAE | 115 | | | 2.21 | 0.09 | 1.32 | 0.79 | AAE |
| | (3.00 g) | | | (2.52) | | | (2.52) | | | | | | | | (10.51) |
| Cat 15 | MagTi | 115 | (2.42) | AAE | 115 | | AAE | 115 | | AAE | 2.30 | 0.20 | 0.22 | 0.31 | AAE |
| | (3.00 g) | | | (2.52) | | | (2.52) | | | (2.52) | | | | | (15.74) |
| Cat 16 | MagTi | 115 | (2.42) | AAE-2 | 115 | | | 115 | | | 3.64 | 0.19 | 5.58 | 1.68 | AAE-2 |
| | (3.00 g) | | | (2.52) | | | | | | | | | | | (3.55) |
| Cat 17 | MagTi | 115 | (2.42) | AAE-2 | 115 | | AAE-2 | 115 | | | 2.81 | 0.47 | 1.63 | 0.35 | AAE-2 |
| | (3.00 g) | | | (2.52) | | | (2.52) | | | | | | | | (2.53) |
| Cat 18 | MagTi | 115 | (2.42) | AAE-2 | 115 | | AAE-2 | 115 | | AAE-2 | 2.60 | 0.53 | 0.40 | 0.02 | AAE-2 |
| | (3.00 g) | | | (2.52) | | | (2.52) | | | (2.52) | | | | | (1.35) |
| Cat 19 | MagTi | 115 | (1.82) | AAE | 115 | (0.60) | AAE | 115 | | | 2.64 | 0.09 | 1.78 | 0.72 | AAE |
| | (3.00 g) | | | (2.52) | | | (2.52) | | | | | | | | (12.40) |
| Cat 20 | MagTi | 115 | (1.82) | AAE | 115 | (0.60) | AAE | 115 | | AAE | 2.84 | 0.11 | trace | 0.28 | AAE |
| | (3.00 g) | | | (2.52) | | | (2.52) | | | (2.52) | | | | | (16.65) |
| Cat 21 | MagTi | 115 | (1.82) | AAE-2 | 115 | (0.60) | | 115 | | | 3.17 | 0.12 | 3.30 | 0.21 | AAE-2 |
| | (3.00 g) | | | (2.52) | | | | | | | | | | | (5.28) |
| Cat 22 | MagTi | 115 | (1.82) | AAE-2 | 115 | (0.60) | AAE-2 | 115 | | | 3.06 | 0.33 | 7.90 | 0.53 | AAE-2 |
| | (3.00 g) | | | (2.52) | | | (2.52) | | | | | | | | (2.70) |

TABLE 9
Polymerization Data of Catalysts Adding Alkoxyalkyl Ester Compounds as a Second Internal Donor

| | | | | MF | | | Activity | Pro- | | | |
|---|---|---|---|---|---|---|---|---|---|---|---|
| Run | Pro- | | BD | (g/10 | XSV | XSH | (kg/g- | catalyst | TEAl | Al/ | H₂ |
| # | Catalyst | SCA | (g/cc) | min) | (%) | (%) | hr) | (mg) | (mmol) | SCA | (scc) |
| 1C | Comp 1 | DCPDMS | 0.33 | 4.1 | 2.98 | 3.42 | 31.9 | 4.3 | 2 | 8 | 3000 |
| 2C | Comp 2 | DCPDMS | 0.22 | 1.4 | 2.46 | 1.74 | 53.5 | 4.3 | 2 | 8 | 3000 |
| 3C | Comp 3 | DCPDMS | 0.25 | 1.2 | 2.10 | 1.8 | 57.2 | 4.3 | 2 | 8 | 3000 |
| 14 | Cat 14 | DCPDMS | 0.34 | 3.7 | 2.30 | 3.00 | 40.5 | 4.3 | 2 | 8 | 3000 |
| 15 | Cat 15 | DCPDMS | 0.37 | 3.4 | 1.78 | 2.75 | 31.9 | 4.3 | 2 | 8 | 3000 |
| 16 | Cat 16 | DCPDMS | 0.29 | 2.0 | 2.66 | 2.49 | 48.4 | 4.3 | 2 | 8 | 3000 |
| 17 | Cat 17 | DCPDMS | 0.38 | 6.0 | 2.39 | 3.4 | 34.7 | 4.3 | 2 | 8 | 3000 |
| 18 | Cat 18 | DCPDMS | 0.40 | 4.6 | 2.49 | 3.04 | 14.4 | 4.3 | 2 | 8 | 3000 |
| 19 | Cat 19 | DCPDMS | 0.29 | 1.9 | 2.14 | 2.19 | 35.6 | 4.3 | 2 | 8 | 3000 |
| 20 | Cat 20 | DCPDMS | 0.34 | 2.8 | 2.09 | 2.93 | 30.9 | 4.3 | 2 | 8 | 3000 |
| 21 | Cat 21 | DCPDMS | 0.34 | 2.3 | 2.00 | 2.28 | 47.2 | 4.3 | 2 | 8 | 3000 |
| 22 | Cat 22 | DCPDMS | 0.31 | 3.4 | 2.48 | 2.49 | 44.7 | 4.3 | 2 | 8 | 3000 |

TABLE 10
Preparation of Catalysts Pretreating the Support with Benzoyl Compounds

| | | 1^{st} TiCl₄ Contacting | | | 2^{nd} TiCl₄ Contacting | | | 3^{rd} TiCl₄ Contacting | | | | | | | |
|---|---|---|---|---|---|---|---|---|---|---|---|---|---|---|---|
| | Precursor | | SPAD | Add. | | SPAD | Add. | | SPAD | Add. | | | | | |
| Pro- | Amount | Temp | Amount | Donor | Temp | Amount | Donor | Temp | Amount | Donor | Ti | EtO | SPAD | EB | Other |
| Catalyst | (g) | (° C.) | (mmol) | (mmol) | (° C.) | (mmol) | (mmol) | (° C.) | (mmol) | (mmol) | (%) | (%) | (%) | (%) | (%) |
| Comp 5 | MagTi | 115 | | DIBP | 115 | | | 115 | | | 3.18 | 0.26 | | | DIBP |
| | (3.00 g) | | | (2.42) | | | | | | | | | | | (10.92) |
| Comp 6 | MagTi | 100 | (2.42) | | 100 | | | 115 | | | 3.49 | 0.47 | 26.16 | 0.57 | |
| | (3.00 g) | | | | | | | | | | | | | | |
| Cat 23 | MagTi | 70 | | EB | 100 | (2.42) | | 115 | | | 2.98 | 0.11 | 21.58 | 1.54 | |
| | (3.00 g) | | | (2.42) | | | | | | | | | | | |
| Cat 24 | MagTi | 70 | | EB | 115 | (2.42) | | 115 | | | 2.66 | 0.28 | 17.69 | 1.99 | |
| | (3.00 g) | | | (2.42) | | | | | | | | | | | |
| Cat 25 | MagTi | 70 | | EB | 115 | (2.42) | | 115 | (1.45) | | 3.27 | 0.20 | 16.91 | 1.49 | |
| | (3.00 g) | | | (2.42) | | | | | | | | | | | |
| Cat 26 | MagTi | 70 | | EB | 100 | (3.63) | | 115 | | | 2.72 | 0.27 | 21.56 | 1.59 | |
| | (3.00 g) | | | (2.42) | | | | | | | | | | | |
| Cat 27 | MagTi | 70 | | EB | 115 | (3.63) | | 115 | | | 2.59 | 0.25 | 15.45 | 1.96 | |
| | (3.00 g) | | | (2.42) | | | | | | | | | | | |
| Cat 28 | MagTi | 70 | | EB | 100 | (2.42) | | 115 | | | 3.85 | 0.28 | 19.90 | 2.93 | |
| | (3.00 g) | | | (4.84) | | | | | | | | | | | |
| Cat 29 | MagTi | 70 | | EB | 115 | (2.42) | | 115 | | | 3.38 | 0.33 | 15.86 | 3.30 | |
| | (3.00 g) | | | (4.84) | | | | | | | | | | | |
| Cat 30 | MagTi | 70 | | EB | 115 | | EB | 115 | (2.42) | | 3.33 | 0.12 | 12.19 | 4.70 | |
| | (3.00 g) | | | (2.42) | | | (2.42) | | | | | | | | |
| Cat 31 | MagTi | 70 | | EB | 100 | | BC | 100 | (2.42) | | 3.20 | 0.21 | 15.28 | 4.13 | |
| | (3.00 g) | | | (2.42) | | | (4.24) | | | | | | | | |
| Cat 32 | MagTi | 100 | | BC | 100 | (2.42) | | 115 | | | 3.54 | 0.37 | 15.06 | 2.58 | |
| | (3.00 g) | | | (4.24) | | | | | | | | | | | |
| Cat 33 | MagTi | 100 | | BC | 100 | | BC | 100 | (2.42) | | 4.23 | 0.14 | 13.55 | 3.98 | |
| | (3.00 g) | | | (4.24) | | | (4.24) | | | | | | | | |
| Cat 34 | MagTi | 70 | | PEEB | 100 | (2.42) | | 115 | | | 2.69 | 0.23 | 19.96 | 0.32 | PEEB |
| | (3.00 g) | | | (2.42) | | | | | | | | | | | (trace) |
| Cat 35 | MagTi | 70 | | PEEB | 100 | (3.63) | | 115 | | | 2.92 | 0.47 | 17.99 | 0.55 | PEEB |
| | (3.00 g) | | | (2.42) | | | | | | | | | | | (trace) |
| Cat 36 | MagTi | 70 | | PEEB | 100 | (2.42) | | 115 | | | | | | | |
| | (3.00 g) | | | (4.84) | | | | | | | | | | | |
| Cat 37 | MagTi | 115 | | AAE | 100 | (2.42) | | 115 | | | | | | | |
| | (3.00 g) | | | (1.82) | | | | | | | | | | | |
| Cat 38 | MagTi | 115 | | EB | 115 | | EB | 115 | (2.42) | BC | | | | | |
| | (2.00 g) | | | (2.52) | | | (2.52) | | | (2.52) | | | | | |

TABLE 11
Polymerization Data of Catalysts Pretreating the Support with Benzoyl Compounds

| | | | | MF | | | Activity | Pro- | | | |
|---|---|---|---|---|---|---|---|---|---|---|---|
| Run | Pro- | | BD | (g/10 | XSV | XSH | (kg/g- | catalyst | TEAl | Al/ | H₂ |
| # | Catalyst | SCA | (g/cc) | min) | (%) | (%) | hr) | (mg) | (mmol) | SCA | (scc) |
| 5C | Comp 5 | DCPDMS | 0.31 | 8.3 | 3.66 | 3.87 | 35.6 | 4.6 | 2 | 22 | 3000 |
| 6C | Comp 6 | DCPDMS | 0.25 | 4.2 | 2.87 | 2.22 | 51.2 | 4.6 | 2 | 22 | 3000 |
| 23 | Cat 23 | DCPDMS | 0.37 | 2.4 | 1.07 | 1.77 | 37.4 | 4.6 | 2 | 22 | 3000 |
| 24 | Cat 24 | DCPDMS | 0.37 | 10.4 | 1.88 | 2.20 | 40.2 | 4.6 | 2 | 22 | 3000 |
| 25 | Cat 25 | DCPDMS | 0.37 | 2.0 | 1.74 | 2.03 | 31.0 | 4.6 | 2 | 22 | 3000 |
| 26 | Cat 26 | DCPDMS | 0.38 | 2.8 | 1.15 | 1.90 | 32.1 | 4.6 | 2 | 22 | 3000 |
| 27 | Cat 27 | DCPDMS | 0.37 | 4.9 | 2.05 | 2.44 | 40.9 | 4.6 | 2 | 22 | 3000 |
| 28 | Cat 28 | DCPDMS | 0.38 | 3.4 | 2.30 | 3.03 | 52.3 | 4.6 | 2 | 22 | 3000 |
| 29 | Cat 29 | DCPDMS | 0.35 | 4.0 | 2.64 | 2.88 | 42.0 | 4.6 | 2 | 22 | 3000 |
| 30 | Cat 30 | DCPDMS | 0.37 | 2.1 | 2.14 | 2.97 | 48.6 | 4.6 | 2 | 22 | 3000 |
| 31 | Cat 31 | DCPDMS | 0.38 | 1.9 | 1.66 | 2.47 | 52.7 | 4.6 | 2 | 22 | 3000 |
| 32 | Cat 32 | DCPDMS | 0.37 | 3.3 | 2.88 | 3.43 | 55.4 | 4.6 | 2 | 22 | 3000 |
| 33 | Cat 33 | DCPDMS | 0.36 | 2.1 | 3.03 | 3.43 | 51.2 | 4.6 | 2 | 22 | 3000 |
| 34 | Cat 34 | DCPDMS | 0.38 | 10.5 | 1.63 | 2.52 | 27.3 | 4.6 | 2 | 22 | 3000 |
| 35 | Cat 35 | DCPDMS | 0.36 | 2.2 | 1.70 | 2.37 | 18.5 | 4.6 | 2 | 22 | 3000 |
| 36 | Cat 36 | DCPDMS | 0.37 | 7.5 | 2.43 | 2.61 | 23.5 | 4.6 | 2 | 22 | 3000 |
| 37 | Cat 37 | DCPDMS | 0.38 | 3.5 | 3.00 | 3.64 | 43.1 | 4.6 | 2 | 22 | 3000 |

TABLE 12
Polymerization Data of Pretreated Catalysts Using Varied External Donors

| | | | | MF | | | Activity | Pro- | | | |
|---|---|---|---|---|---|---|---|---|---|---|---|
| Run | Pro- | | BD | (g/10 | XSV | XSH | (kg/g- | catalyst | TEAl | Al/ | H₂ |
| # | Catalyst | SCA | (g/cc) | min) | (%) | (%) | hr) | (mg) | (mmol) | SCA | (scc) |
| 1C | Comp 1 | DCPDMS | 0.33 | 4.1 | 2.98 | 3.42 | 31.9 | 4.3 | 2 | 8 | 3000 |
| 2C | Comp 2 | DCPDMS | 0.22 | 1.4 | 2.46 | 1.74 | 53.5 | 4.3 | 2 | 8 | 3000 |
| 38 | Cat 38 | DCPDMS | 0.38 | 1.1 | 2.83 | 3.23 | 60.2 | 4.3 | 2 | 8 | 3000 |
| 39 | Cat 38 | NPTMS | 0.36 | No | 1.96 | 0.78 | 28.1 | 4.3 | 1 | 4 | 2000 |
| | | | | flow | | | | | | | |
| 40 | Cat 38 | TEOS | 0.34 | 1.4 | 3.23 | 2.38 | 41.2 | 4.3 | 1 | 4 | 2000 |
| 41 | Cat 38 | PTES | 0.34 | 2.1 | 3.02 | 2.09 | 43.5 | 4.3 | 1 | 4 | 2000 |
| 42 | Cat 38 | PTES | 0.34 | 2.3 | 4.14 | 3.11 | 48.6 | 4.3 | 1 | 40 | 2000 |

As shown in tables 4-12, multi-contact in the presence of SPAD, a benzoate-based component, and/or an alkoxyalkyl ester unexpectedly improves (i) catalyst activity and (ii) polymer bulk density.

It is specifically intended that the present disclosure not be limited to the embodiments and illustrations contained herein, but include modified forms of those embodiments including portions of the embodiments and combinations of elements of different embodiments as come within the scope of the following claims.

1. A process for producing a procatalyst composition comprising:
first contacting a procatalyst precursor with a halogenating agent in the presence of an internal electron donor selected from the group consisting of a substituted phenylene aromatic diester, a benzoate-based component, an alkoxyalkyl ester, and combinations thereof to form a procatalyst intermediate;
second contacting the procatalyst intermediate with a halogenating agent in the presence of an internal electron donor selected from the group consisting of a substituted phenylene aromatic diester, a benzoate-based component, an alkoxyalkyl ester, and combinations thereof, at least one of the contact steps occurring in the presence of a substituted phenylene aromatic dibenzoate; and
forming a multi-contact procatalyst composition.

2. The process of claim 1 comprising performing the first contacting and the second contacting in the presence of a 3-methyl-5-t-butyl-1,2-phenylene dibenzoate.

3. The process of claim 1 comprising forming a residual composition having a structure selected from group consisting of (VI), (VII), (VIII), (IX), (X), and combinations thereof 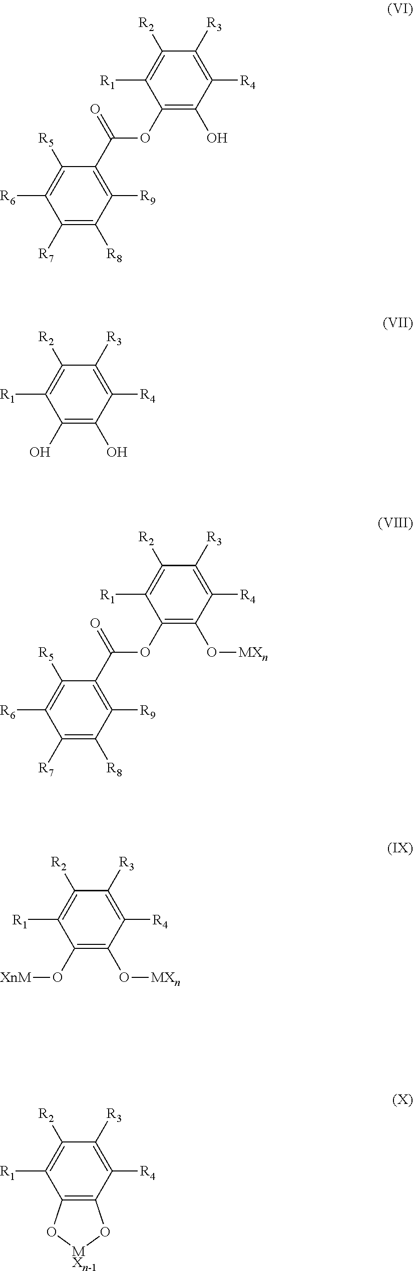
wherein each of R₁-R₉ is the same or different, each of R₁-R₉ is selected from the group consisting of hydrogen and a C₁-C₆ hydrocarbyl group;
M is magnesium or titanium;
n is 1 when M is magnesium, n is 3 when M is titanium; and
X is a halogen atom.

5. A process for producing a procatalyst composition comprising:
first contacting a procatalyst composition with a halogenating agent in the presence of a substituted phenylene aromatic dibenzoate and an alkoxyalkyl ester to form a procatalyst intermediate; and
second contacting the procatalyst intermediate with a halogenating agent in the presence of an internal electron donor selected from the group consisting of a substituted phenylene aromatic diester, an alkoxyalkyl ester, and combinations thereof; and
forming a multi-contact procatalyst composition comprising a substituted phenylene aromatic diester and an alkoxyalkyl ester.

6. The process of claim 5 comprising second contacting the procatalyst intermediate with a halogenating agent in the presence of an alkoxyalkyl ester.

7. The process of any of claims 5-6 comprising second contacting the procatalyst intermediate with a halogenating agent in the presence of a substituted phenylene aromatic dibenzoate and an alkoxyalkyl ester.

8. The process of any of claims 5-7 comprising third contacting the procatalyst intermediate with an alkoxyalkyl ester.

9. A process for producing a procatalyst composition comprising:
first contacting a procatalyst composition with a halogenating agent in the presence of a benzoate-based component to form a procatalyst intermediate; and
second contacting the procatalyst intermediate with a halogenating agent in the presence of a substituted phenylene aromatic diester; and
forming a multi-contact procatalyst composition comprising a substituted phenylene aromatic diester and a benzoate-based component.

10. The process of claim 9 comprising third contacting the procatalyst intermediate with a halogenating agent and a substituted phenylene aromatic diester.

11. A catalyst composition comprising:
the multi-contact procatalyst composition of claim 1;
a cocatalyst; and
optionally an external electron donor.

12. The catalyst composition of claim 11 comprising a residual composition.

13. A polymerization process comprising:
contacting, under polymerization conditions, propylene and optionally one or more comonomers with a catalyst composition comprising the multi-contact procatalyst composition of claim 1, a cocatalyst and an external electron donor; and
forming particles of a propylene-based polymer having a bulk density greater than 0.30 g/cc.
